(19) United States
(12) Patent Application Publication
(10) Pub. No.: US 2011/0050507 A1
(43) Pub. Date: Mar. 3, 2011

(54) RADIO COMMUNICATION DEVICE

(75) Inventor: Tetsu Miyakawa, Yokohama-shi (JP)

(73) Assignee: Kyocera Corporation, Kyoto (JP)

(21) Appl. No.: 12/934,977

(22) PCT Filed: Mar. 24, 2009
(86) PCT No.: PCT/JP2009/055766

§ 371 Date: Nov. 9, 2010

(30) Foreign Application Priority Data
Mar. 28, 2008 (JP) 2008-087981

(51) Int. Cl. H01Q 1/38

(52) U.S. Cl. 343/700 MS

(57) ABSTRACT

A radio communication device according to the present invention which is inserted into an expansion slot of an electronic device, includes: a printed circuit board having a rectangular shape, and provided with a connection terminal on one short side that connects to the expansion slot; an antenna element provided on the printed circuit board extending in a direction orthogonal thereto in the vicinity of an other short side of the printed circuit board, and having a substantially ¼ λ electrical length; and a radial line extending on the printed circuit board with a position where the antenna element is arranged as an end point.

### TECHNICAL FIELD

The present invention relates to a radio communication device.

Priority is claimed on Japanese Patent Application No. 2008-087981, filed Mar. 28, 2008, the content of which is incorporated herein by reference.

### BACKGROUND ART

As a radio communication device, a PC card that has an antenna built-in inside a casing, and that is used inserted into an expansion slot of a personal computer or the like, has been put to practical use. This built-in antenna type PC card has been developed with the object of further miniaturizing PC cards furnished with movable external antennas. This PC card achieves miniaturization by mounting a built-in antenna within a casing instead of providing an external antenna outside of the casing. As technology related to the PC card with built-in antenna, Patent document 1 below discloses a compact antenna (reverse-F antenna), and a PC card with this compact antenna built-in, that can receive a desired vertical polarization component, and can widen the frequency bandwidth of VSWR, even when built-into a PC card or the like of uniform thickness.

The compact antenna is constituted by a substrate and chip parts made of resin that are mounted on the substrate. The substrate includes ground conductors formed on the back of the substrate, a first short-circuit conductor wiring formed on a main surface of the substrate, and a through-hole that connects these. The chip parts include a second short-circuit conductor wiring, a radiating conductor, a short-circuit conductor, and a power supply conductor wiring. The second short-circuit conductor wiring is formed on the underside of the chip parts and faces the first short-circuit conductor wiring on the substrate. The radiating conductor is formed on the upper surface of the chip parts. The short-circuit conductor is formed on the end surface of the chip parts, and connects the second short-circuit conductor wiring and the radiating conductor. The power supply conductor wiring is formed on the side surface of the chip parts and is connected to the radiating conductor.

[Patent Document 1] Japanese Unexamined Patent Application, First Publication No. 2003-133847

### DISCLOSURE OF INVENTION

### Problem to be Solved by the Invention

In the above-mentioned PC card type radio communication device, a ground pattern that is formed horizontally with respect to a printed circuit board, picks up radiated waves in a horizontal direction, which strengthens the horizontal polarization component of the radio wave. In particular, in a PC card-type radio communication device that uses a built-in antenna, the strength of the vertical polarization component of the radio wave is weaker than in a device that has a movable external antenna. In Patent document 1 above, there is disclosed a PC card with built-in antenna that is able to obtain a desired vertical polarization component. However, even when this PC card is used, the strength of the vertical polarization component is relatively weak compared to a PC card with a movable external antenna.

The PC card type radio communication device mainly transmits and receives vertically polarized radio waves. Therefore by right, the strength of the vertical polarization component of the radio wave needs to be increased. However, with the PC card type radio communication device that uses the abovementioned built-in antenna, the strength of the vertical polarization component tends to be weak due to miniaturization. However, in order to realize stable radio quality as a PC card type radio communication device, the strength of the vertical polarization component also when using the built-in antenna, needs to be made stronger.

The present invention takes into consideration the above situation, and an object thereof is to provide a PC card type radio communication device that uses a built-in antenna and which is capable of increasing the strength of the vertical polarization component of radio waves to a greater extent than heretofore.

### Means for Solving the Problem

To achieve the object, a radio communication device according to the present invention which is inserted into an expansion slot of an electronic device, includes: a printed circuit board having a rectangular shape, and provided with a connection terminal on one short side that connects to the expansion slot; an antenna element provided on the printed circuit board extending in a direction orthogonal thereto in the vicinity of an other short side of the printed circuit board, and having a substantially ¼ λ electrical length; and a radial line extending on the printed circuit board with a position where the antenna element is arranged as an end point.

In the radio communication device according to the present invention, a plurality of radial lines may be provided in a radial pattern on the printed circuit board with a position where the antenna element is arranged as a center.

In the radio communication device according to the present invention, a length of the radial line from the end point to an other end point may substantially ¼ λ electrical length.

In the radio communication device according to the present invention, the radial line may be electrically connected to a ground included in the printed circuit board.

In the radio communication device according to the present invention, the radial line may be provided on a surface on an opposite side to a surface of the printed circuit board on which the antenna element is arranged.

In the radio communication device according to the present invention, the antenna element may be one of a helical antenna and a chip antenna.

### Effect of the Invention

A radio communication device according to the present invention which is inserted into an expansion slot of an electronic device, includes: a printed circuit board having a rectangular shape, and provided with a connection terminal on one short side that connects to the expansion slot; an antenna element provided on the printed circuit board extending in a direction orthogonal thereto in the vicinity of an other short side of the printed circuit board, and having a substantially ¼ λ electrical length; and a radial line extending on the printed circuit board with a position where the antenna element is arranged as an end point. Therefore, a ground plane antenna is formed on the printed circuit board, and by means of the ground plane antenna, radio waves having an electric field in the same direction as the direction orthogonal to the printed circuit board, that is, radio waves including mainly the vertical polarization component, can be radiated and received. Consequently, according to the present invention, the strength of the vertical polarization component of the radio waves can be made stronger than heretofore. Furthermore, due to the cooperation between the antenna element and the radial line, a situation where the radio wave is terminated in the ground pattern formed horizontally with respect to the printed circuit board can be prevented. Therefore the strength of the vertical polarization component can be increased.

### BRIEF DESCRIPTION OF THE DRAWINGS

FIG. 1 is a perspective view showing a schematic configuration of the interior of a PC card with built-in antenna according to an embodiment of the present invention, with a casing removed.

FIG. 2A is a schematic diagram illustrating radiation and reception theory of radio waves in a ground plane antenna constituted by a helical antenna and a radial line, of the PC card with built-in antenna according to the embodiment of the present invention.

FIG. 2B is a schematic diagram illustrating radiation and reception theory of radio waves in the ground plane antenna constituted by the helical antenna and the radial line, of the PC card with built-in antenna according to the embodiment of the present invention.

FIG. 2C is a schematic diagram illustrating radiation and reception theory of radio waves in the ground plane antenna constituted by the helical antenna and the radial line, of the PC card with built-in antenna according to the embodiment of the present invention.

### REFERENCE SYMBOLS

A PC card with built-in antenna

1 Printed circuit board

1a Ground pattern

1b Connector

1c Micro-strip line

1d Power supply line

1e Radial line

1f Ground plane

2 Helical antenna

2a Dielectric substance

2b Conductive line

### BEST MODE FOR CARRYING OUT THE INVENTION

Hereunder is a description of an embodiment of the present invention with reference to the drawings. This embodiment conforms to the specifications of the Personal Computer Memory Card International Association (PCMCIA). This embodiment is related to a PC (Personal Computer) card with built-in antenna in which an antenna is built-in inside a casing. The PC card with built-in antenna in the present embodiment is the radio communication device in the present invention.

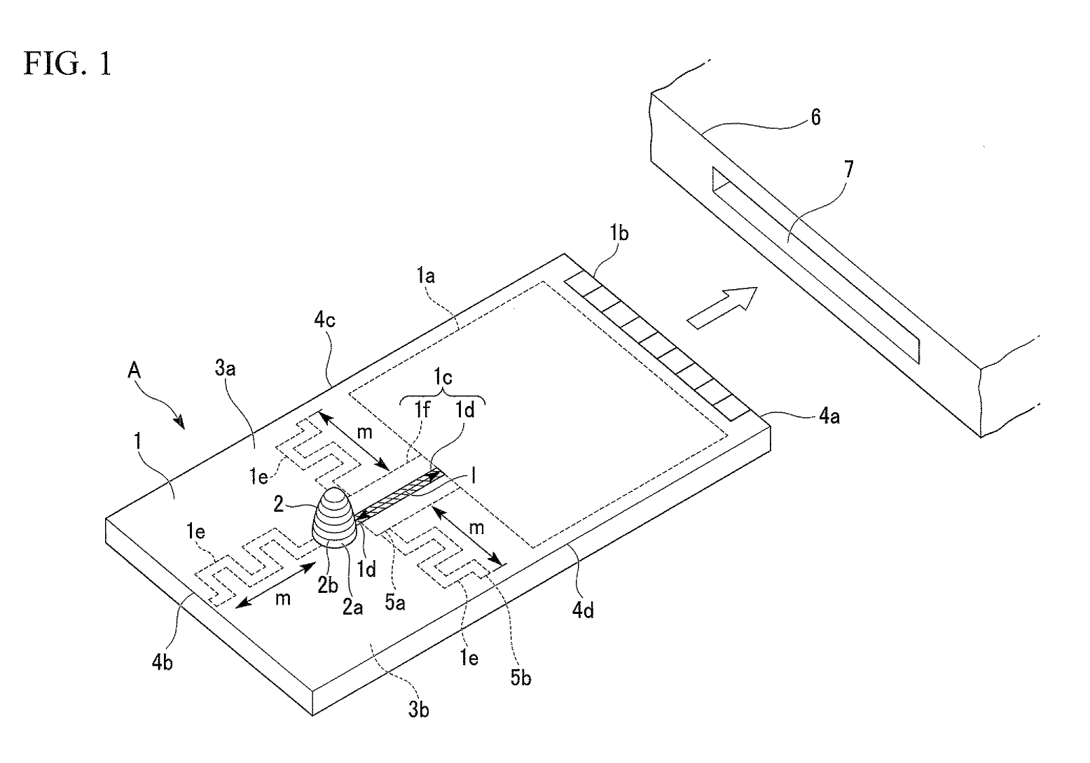

FIG. 1 is a perspective view showing a schematic configuration of the interior of a PC card with built-in antenna A according to the present embodiment, with the casing removed. The PC card with built-in antenna A is inserted into an expansion slot of a notebook type personal computer as shown in the figure. The PC card with built-in antenna A, under instructions of the notebook type personal computer, performs wireless communication with an external device using the vertical polarization component of radio waves.

The PC card with built-in antenna A includes a printed circuit board 1, a helical antenna 2, and a casing serving as an exterior part (omitted from the drawing).

The printed circuit board 1 is a rectangular two layer substrate in which a ground pattern 1a and a signal pattern are formed sequentially from the back face layer. In the printed circuit board 1, a connector 1b is provided on one of the short sides.

This connector 1b is connected to a connector inside the expansion slot 7 of the notebook type personal computer 6. In the following description, in the printed circuit board 1, the short side on which the connector 1b is provided is called the printed circuit board bottom edge 4a, and the short side on the opposite side to the connector 1b is called the printed circuit board top edge 4b. Furthermore, the side on the right side facing the printed circuit board bottom edge 4a is called the printed circuit board right edge 4c, and the side on the opposite side to the printed circuit board right edge 4c is called the printed circuit board left edge 4d. The ground pattern 1a in the back face layer of the printed circuit board 1 is formed on the back face 3b spanning from near the longitudinal center of the printed circuit board 1 to the vicinity of the connector 1b.

The helical antenna 2 captures the reception radio wave, and outputs this to an RF circuit (not shown in the figure) as a received signal. On the other hand, the helical antenna 2 radiates the transmission signal input from the RF circuit into the air as a transmission radio wave. The helical antenna 2 is arranged at a position separated from the center of one edge on the printed circuit board top edge 4b side of the ground pattern 1a, by just ⅛ λ electrical length in the direction of the printed circuit board top side (in FIG. 1, the length of the arrow denoted by reference symbol 1). The helical antenna 2 includes a dielectric substance 2a, and a conductive line 2b, and is formed by winding the conductive line 2b which has a ¼ λ electrical length in a coil shape on the dielectric substance 2a serving as a core. Here λ is the wavelength of the radio wave used in radio communication.

A power supply line 1d is provided on the printed circuit board 1 on the printed circuit board bottom edge 4a side of the helical antenna 2. This power supply line 1d is constructed from copper foil or the like that constitutes a micro-strip line 1c. Power supply to the helical antenna 2 is performed via the power supply line 1d of the micro-strip line 1c. The micro-strip line 1c is configured from a ground plane 1f formed on the back face (lower face) 3b and a signal line (power supply line 1d) formed on the front face (upper face) 3a, with a plate material such as a glass epoxy resin or the like having dielectric properties being the base material of the printed circuit board 1 sandwiched therebetween.

On the back face 3b of the printed circuit board 1 there is formed three radial lines 1e constituted from copper foil or the like, radiating from the position where the helical antenna 2 is provided. These three radial lines 1e, with the printed circuit board right edge 4c side of the helical antenna 2, the printed circuit board left edge 4d side of the helical antenna 2, and the printed circuit board top edge 4b side of the helical antenna 2 as an end point 5a, respectively extend to another end point 5b while meandering towards the printed circuit board right edge 4c direction, the printed circuit board left edge 4d direction, and the printed circuit board top edge 4b direction. Consequently, the radial line 1e extended in the printed circuit board right edge 4c direction, and the radial line 1e extended in the printed circuit board top edge 4b direction have a 90 degree angle with respect to each other and are formed on the printed circuit board 1. The radial line 1e extended in the printed circuit board top edge 4b direction, and the radial line 1e extended in the printed circuit board left edge 4d have a 90 degree angle with respect to each other and are formed on the printed circuit board 1. The radial line 1e extended in the printed circuit board left edge 4d, and the radial line 1e extended in the printed circuit board right edge 4c direction have a 180 degree angle with respect to each other, and are formed on the printed circuit board 1.

These three radial lines 1e extend from a position where the helical antenna 2 is provided, and have a length of ¼ λ electrical length (in FIG. 1 the length of the arrow denoted by reference symbol m) in their respective directions of the printed circuit board right edge 4c, the printed circuit board left edge 4d, and the printed circuit board top edge 4b. Furthermore, the three radial lines 1e are electrically connected to the ground plane 1f of the back face 3b of the printed circuit board 1 that forms the micro-strip line 1c. In the PC card with built-in antenna A, the ground plane antenna is formed by the helical antenna 2 and the three radial lines 1e.

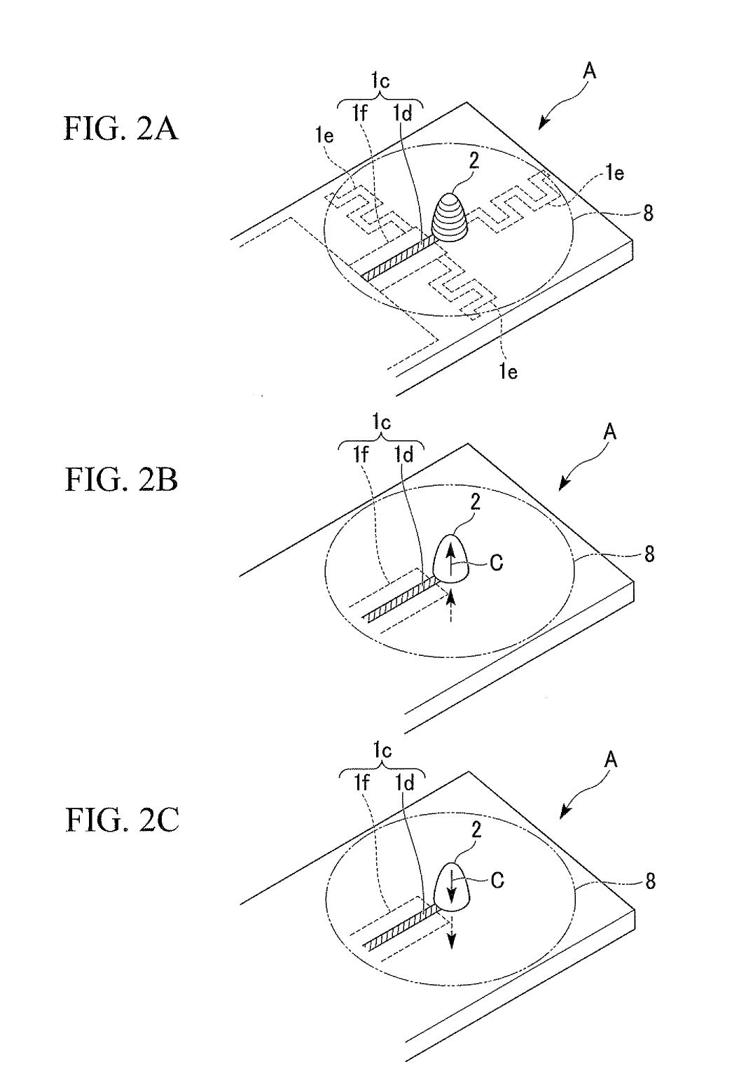

Next, is a description of the radiation and reception theory of radio waves in the ground plane antenna configured by the helical antenna 2 and the radial lines 1e in the PC card with built-in antenna A of the above construction, with reference to FIG. 2A through FIG. 2C. FIG. 2A to FIG. 2C are schematic diagrams illustrating the radiation and reception theory of radio waves in a ground plane antenna constituted by the helical antenna 2 and the radial lines 1e, of the PC card with built-in antenna A according to the present embodiment.

FIG. 2A is a schematic diagram showing a virtual ground 8 that is formed by means of the three radial lines 1e. FIG. 2B is a schematic diagram showing the flow of current in the case where a positive high frequency current C flows to the helical antenna 2. FIG. 2C is a schematic diagram showing the flow of current in the case where a negative high frequency current C flows to the helical antenna 2.

As shown in FIG. 2A, in the PC card with built-in antenna A, by arranging the three radial lines 1e on the printed circuit board radiating from the position of the helical antenna 2, the virtual ground 8 is formed on the printed circuit board 1 centered on the position of the helical antenna 2. As shown in FIG. 2B, when a positive high frequency current C flows from the power supply line 1d to the helical antenna 2, then due to the image effect due to the virtual ground 8, this gives a state equivalent to a state where, with the virtual ground 8 interposed, the current flows from a direction opposite to the direction that the helical antenna 2 protrudes towards the connection point between the power supply line 1d and the helical antenna 2.

Furthermore, as shown in FIG. 2C, when a negative high frequency current C flows from the power supply line 1d to the helical antenna 2, then due to the image effect, this gives a state equivalent to a state where the current flows from the connection point between the power supply line 1d and the helical antenna 2, with the virtual ground 8 interposed, in the direction opposite to the direction that the helical antenna 2 protrudes. As a result, in the PC card with built-in antenna A, this gives a state equivalent to the state where a dipole antenna of ½ λ electrical length exists, and the radio wave having an electric field in the same direction as the extension direction of the helical antenna 2, that is, a radiated wave including mainly a vertical polarization component can be generated. Furthermore, the PC card with built-in antenna A gives a state equivalent to where a dipole antenna exists, thereby enabling the vertical polarization component of the radio wave to be efficiently received.

Next is a description of the protection effect of the radio wave due to the three radial lines 1e, with respect to the radio wave of the helical antenna 2.

In a conventional PC card with built-in antenna, the ground that is formed horizontally with respect to the printed circuit board, picks up the radio waves of the antenna element, which strengthens the horizontal polarization component of the radio wave. Furthermore, distortion is generated in the radio wave of the antenna element due to the noise current generated from the ground.

In the PC card with built-in antenna A, the radial lines 1e arranged on the perimeter of the helical antenna 2 and the ground plane 1f of the micro-strip line 1c are electrically connected, and due to cooperation between the helical antenna 2 and the radial lines 1e, an electric field is formed. As a result, in the PC card with built-in antenna A, a situation where the radio wave of the helical antenna 2 is terminated at the ground pattern 1a is prevented. As a result, the influence from the ground pattern 1a can be kept to a minimum.

As described above, in the PC card with built-in antenna A, the helical antenna 2 is provided at a position separated by just ⅛ λ electrical length from the ground pattern 1a of the printed circuit board 1, and the radial lines 1e are provided radiating from the position of the helical antenna 2 as a center. As a result, a ground plane antenna is formed on the printed circuit board 1, and a radio wave having an electric field in the same direction as the extension direction of the helical antenna 2, that is to say, a radiated electrical wave including mainly the vertical polarization component can be generated.

Furthermore, the radial lines 1e arranged at the periphery of the helical antenna 2, and the ground plane 1f of the micro-strip line 1c are electrically connected, and an electric field is formed due to the cooperation between the helical antenna 2 and the radial line 1e. Therefore the situation where the radio wave of the helical antenna 2 is terminated at the ground pattern 1a is prevented. As a result, since the vertical polarization component of the radio wave of the helical antenna 2 is protected, the strength of the horizontal polarization component of the radio wave can be weakened, that is to say, the strength of the vertical polarization component can be strengthened. Furthermore, the radial lines 1e are provided on the back face 3b of the printed circuit board 1 which is the face on the opposite side to the front face on which the helical antenna 2 is provided. Therefore, between the helical antenna 2 and the radial lines 1e, the dielectric substance of glass epoxy resin or the like which is the base material of the printed circuit board 1 is sandwiched. As a result, the permittivity is increased, so that the helical antenna 2 can be miniaturized, that is, it is possible to make the PC card with built-in antenna even thinner.

In the above, an embodiment of the present invention has been described. However, the present invention is not limited to this embodiment, and for example the following modifications can be considered.

(1) In the embodiment, for the antenna element, the helical antenna 2 is provided on the printed circuit board 1; however, the present invention is not limited to this.

For example, instead of the helical antenna 2, a chip antenna may be mounted on the printed circuit board 1 as an antenna element.

(2) In the embodiment, three radial lines 1e are provided centered on the position of the helical antenna 2; however, the present invention is not limited to this.

For example, rather than three, two or one are possible. Furthermore, four or more radial lines may be provided. Since the performance is improved as the virtual ground 8 becomes close to a circle of radius ¼ λ electrical length, if the number of radial lines 1e is increased, the performance as a ground plane antenna is improved with the increase.

(3) In the embodiment, the radial lines 1e are provided on the back face 3b of the printed circuit board 1 which is the surface on the opposite side to the front face where the helical antenna 2 is provided; however, the present invention is not limited to this.

For example, the radial lines 1e may be provided on the front face 3a of the printed circuit board 1 which is the same as the surface where the helical antenna 2 is provided.

(4) In the embodiment, the end points 5a of the two radial lines 1e which have the end points on the printed circuit board right edge 4c of the helical antenna 2 and the printed circuit board left edge 4d of the helical antenna 2, are formed on the printed circuit board 1 so as to connect to the ground plane 1f of the micro-strip line 1c; however, the present invention is not limited to this.

For example, in the case where the distance between the helical antenna 2 and the ground pattern 1a is shorter than ⅛ λ electrical length, that is, the helical antenna 2 and the ground pattern 1a are adjacent, the two radial lines 1e may be extended towards the helical antenna 2 with the central vicinity of one edge on the printed circuit board top edge 4b side in the ground pattern 1a as the end point, and bent at right angles before the helical antenna 2, and extended while meandering towards the printed circuit board right edge 4c or towards the printed circuit board left edge 4d.

### INDUSTRIAL APPLICABILITY

The present invention can be applied to a radio communication device. According to a radio communication device, the strength of the vertical polarization component of the radio wave can be made stronger than heretofore.

1. A radio communication device which is inserted into an expansion slot of an electronic device, comprising:
a printed circuit board having a rectangular shape, and provided with a connection terminal on one short side that connects to the expansion slot;
an antenna element provided on the printed circuit board extending in a direction orthogonal thereto in the vicinity of an other short side of the printed circuit board, and having a substantially ¼ λ electrical length; and
a radial line extending on the printed circuit board with a position where the antenna element is arranged as an end point.

2. The radio communication device according to claim 1, wherein a plurality of radial lines are provided in a radial pattern on the printed circuit board with a position where the antenna element is arranged as a center.

3. The radio communication device according to claim 1, wherein a length of the radial line from the end point to an other end point is substantially ¼ λ electrical length.

4. The radio communication device according to claim 1, wherein the radial line is electrically connected to a ground included in the printed circuit board.

5. The radio communication device according to claim 1, wherein the radial line is provided on a surface on an opposite side to a surface of the printed circuit board on which the antenna element is arranged.

6. The radio communication device according to claim 1, wherein the antenna element is one of a helical antenna and a chip antenna.
